(19) United States
(12) Patent Application Publication
(10) Pub. No.: US 2004/0121175 A1
(43) Pub. Date: Jun. 24, 2004

(54) Layered articles having polyoxymethylene blend substrates with enhanced surface properties and at least one layer thereon and process for making the same

(76) Inventors: Edmund A. Flexman, Wilmington, DE (US); Stefan Greulich, Wilmington, DE (US); Kimberly L. Richmann, St. Louis, MO (US); Pascal Scaramuzzino, Luasanne (CH)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/723,653

(22) Filed: Nov. 26, 2003

Related U.S. Application Data
(60) Provisional application No. 60/435,090, filed on Dec. 20, 2002.

(51) Int. Cl. B32B 27/00

(52) U.S. Cl. 428/515; 428/522

(57) ABSTRACT

The present invention relates to layered articles comprising (a) a substrate comprising 99.5-40 weight percent of an polyoxymethylene polymer; and 0.5-60 weight percent of at least one non-acetal thermoplastic polymer; and (b) at least one additional layer deposited thereon.

This application claims the benefit of U.S. Provisional Application No. 60/435,090 filed Dec. 20, 2002 which is incorporated by reference herein for all purposes as if fully set forth.

### BACKGROUND OF THE INVENTION

1. Field of the Invention

This invention relates to layered articles comprising a polyoxymethylene blend substrate having at least one discontinuous or co-continuous layer adhered thereon, wherein the substrate comprises a blend of compositions that provide enhanced surface adhesion, thereby allowing the application of the at least one layer such as, for example, a coating or overmolding of paints, thermoplastic elastomers, glues and the like.

2. Description of Related Art

Polyoxymethylene compositions are useful as engineering resins due to the positive physical properties they possess, thus allowing polyoxymethylene to be a preferred material for a wide variety of end-uses. Articles made from polyoxymethylene compositions typically possess extremely desirable physical properties such as high stiffness, high strength and solvent resistance. However because of their highly crystalline surface, such articles also have low levels of adhesion, wherein it is difficult, if not impossible to readily paint, glue, or print on such surfaces, overmold such articles with thermoplastic polymers or adhere some other type of layer to the surface of the substrate.

Polyoxymethylene compositions are generally understood to include compositions based on homopolymers of formaldehyde or of cyclic oligomers of formaldehyde, for example trioxane, the terminal groups of which are end-capped by esterification or etherification, as well as copolymers of formaldehyde or of cyclic oligomers of formaldehyde, with oxyalkylene groups having at least two adjacent carbon atoms in the main chain, the terminal groups of which copolymers can be hydroxyl terminated or can be end-capped by esterification or etherification. The proportion of the comonomers can be up to 20 weight percent. Compositions based on polyoxymethylene of relatively high molecular weight, for example 20,000 to 100,000, are useful in preparing semi-finished and finished articles by any of the techniques commonly used with thermoplastic materials, such as, for example, compression molding, injection molding, extrusion, blow molding, stamping and thermoforming.

### SUMMARY OF THE INVENTION

The present invention relates to an article comprising:

a) a substrate comprising 99.5-40 weight percent of an polyoxymethylene polymer and 0.5-60 weight percent of at least one non-acetal thermoplastic polymer; and

b) at least one layer adhered to said substrate, wherein the above given weight percents are based upon the total weight of a) and b).

The present invention further relates to a process for making the above-noted article comprising the steps of:

(i) blending a matrix comprising 99.5-40 weight percent of an polyoxymethylene polymer and 0.5-60 weight percent of at least one thermoplastic polymer;

(ii) molding the matrix into a substrate; and

(iii) adhering at least one layer to said substrate.

### DETAILED DESCRIPTION OF THE INVENTION

The present invention relates to articles comprising (a) a substrate comprising 99.5-40 weight percent of a polyoxymethylene polymer; and 0.5-60 weight percent of at least one thermoplastic polymer on or near the surface of the substrate to promote adhesion; wherein the substrate has (b) at least one discontinuous or co-continuous layer adhered to its surface.

Typically, polyoxymethylene based substrates have low levels of adhesion at their surface, therefore it is difficult to make layered articles for commercial purposes such as, for example, “decorated” parts for the automotive industry including, but not limited to, soft touch buttons and switches; household appliances; consumer products including, but not limited to, painted ski bindings and chrome plated caps for perfume bottles; construction parts; furniture, fashion; and industrial uses including, but not limited to, high friction conveyors and sealing clips.

Additionally, utilizing pretreatments or surface modification techniques such as, for example, etching, flaming ionization, sanding, surface cleaning, UV exposure and the like further increase the adhesion between the substrate and the at least one additional layer. The improved adhesion provided by the pre-treatment may result in better test ratings in some of the more severe testing including, but not limited to, scratching with a knife blade, aging of the painted part.

The term “layer(s)” or “layered” or a derivative thereof, as used herein, is meant to refer to the overmolding layer and/or the layer of paint or glue and the like being adhered to the substrate.

As used herein, the terms “adhered,” “adhesion” and derivatives thereof shall mean the adhesion that exists between surfaces in which the adhesive secures the adherents by means of interlocking forces, also known as mechanical adhesion. The level of adhesion, mechanical binding or interlocking can be determined by either the peel test or the cross-hatch test or other test appropriate for the type of adherents and its ultimate use. According to the peel test, adhered elastomers or other overmoldings must have a value of at least 2 pounds per linear inch. According to the cross-hatch test, adhered paints or other printing/decorative layers have a value of 2 or better, however the minimum for commercial utility may be higher.

The term “discontinuous” as used herein refers to a layer (as defined herein) that is adhered to the substrate in a non-continuous or partial manner over the surface area of the substrate. For example, printing, painting, overmolding, etc. in a pattern which is not continuous and/or does not cover the entire substrate such as, but not limited to stripes, polka dots, grids, etc. are a discontinuous layer. The discontinuous layer is any layer that can not be classified as “co-continuous”.

The term “co-continuous” as used herein refers to a layer (as defined herein) that adheres to the substrate (i.e. which is co-continuous with the “layer”) in an uninterrupted or continuous manner over the surface area of the substrate. For example, dip-coating, painting or chrome-plating, etc. of the surface area of the substrate would form a co-continuous layer with the substrate. The co-continuous layer adheres to the surface area of the substrate and there is not a break in the layer (i.e. the layer is a solitary unit).

As used herein, the term “semi-crystalline” shall refer to a polymeric material processing a melting point when heated in a DSC, in contrast to a Tg.

Polyoxymethylene Component

The polyoxymethylene component of the substrate includes homopolymers of formaldehyde or of cyclic oligomers of formaldehyde, the terminal groups of which are end-capped by esterification or etherification, and copolymers of formaldehyde or of cyclic oligomers of formaldehyde and other monomers that yield oxyalkylene groups with at least two adjacent carbon atoms in the main chain, the terminal groups of which copolymers can be hydroxyl terminated or can be end-capped by esterification or etherification.

Typically, substrates according to the present invention comprise about 99.5-40 weight percent of a polyoxymethylene polymer, however about 99.5-55 weight percent of a polyoxymethylene polymer is preferred.

The polyoxymethylenes used in the substrates of the present invention can be branched or linear and will generally have a number average molecular weight in the range of about 10,000 to 100,000, preferably about 20,000 to about 90,000, and more preferably about 25,000 to about 70,000. The molecular weight can be measured by gel permeation chromatography in m-cresol at 160° C. using a DuPont PSM bimodal column kit with nominal pore size of 60 and 100 A. In general, high molecular weight polyoxymethylenes segregate from the second phase material to a greater degree to the non-polyoxymethylene components, and thus addends may show greater adhesion. Although polyoxymethylenes having higher or lower molecular weight averages can be used, depending on the physical and processing properties desired, the polyoxymethylene weight averages mentioned above are preferred to provide the optimum balance of surface adhesion with other physical properties such as high stiffness, high strength and solvent resistance.

As an alternative to characterizing the polyoxymethylene by its number average molecular weight, it can be characterized by its melt flow rate. Polyoxymethylenes which are suitable for use in the blends of the present invention will have a melt flow rate (measured according to ASTM-D-1238, Procedure A, Condition G with a 1.0 mm (0.0413) diameter orifice of 0.1-40 grams/10 minutes). Preferably, the melt flow rate of the polyoxymethylene used in the blends of the present invention will be from about 0.5-35 grams/10 minutes. The most preferred polyoxymethylenes with a melt flow rate of about 1-20 gram/10 minutes.

As indicated above, the polyoxymethylenes used in the substrates of the present invention can be either a homopolymer, a copolymer or a mixture thereof. Copolymers can contain one or more comonomers, such as those generally used in preparing polyoxymethylene compositions. Comonomers more commonly used include alkylene oxides of 2-12 carbon atoms and their cyclic addition products with formaldehyde. The quantity of comonomers will be no more than 20 weight percent, preferably not more than 15 weight percent, and most preferably about 2 weight percent. The most preferred comonomer is ethylene oxide. Generally, polyoxymethylene homopolymer is preferred over copolymer because of its greater stiffness and strength. Preferred polyoxymethylene homopolymers include those whose terminal hydroxyl groups have been end-capped by a chemical reaction to form ester or ether groups, preferably acetate or methoxy groups, respectively.

The polyoxymethylene may also contain those additives, ingredients, and modifiers that are known to be added to polyoxymethylene compositions for improvement in molding, aging, heat resistance, and the like.

Thermoplastic Polymer Component

The at least one non-acetal thermoplastic polymer may be selected from those thermoplastic polymers that are generally used by themselves, or in combination with others, in extrusion and injection molding processes. These polymers are known to those skilled in the art as extrusion and injection molding grade resins, as opposed to those resins that are known for use as minor components (i.e., processing aids, impact modifiers, stabilizers) in polymer compositions.

Generally substrates according to the present invention comprise about 0.5-60 weight percent of at least one non-acetal thermoplastic polymer, however, about 5-20 weight percent of the at least one non-acetal thermoplastic polymer is preferred. The polyoxymethylene/thermoplastic polymer blend substrate of the present invention contains a region, on or near the surface of the substrate, where the non-acetal polymer typically resides to promote adhesion. The thermoplastic polymer resides in this particular region because in a flowing mixture of immiscible fluids, the lowest viscosity liquid will tend to migrate to the region of highest shear. For example, in the case of injection molding, the wall of the mold cavity is the region of high shear, and thus, a higher concentration of the low viscosity polymer melt becomes concentrated somewhat on or near the surface of the part.

Semi-crystalline polyamides, polyesters and polyolefins can also be utilized in the present invention, either alone or in combination with one another, such that, each may be blended with the polyoxymethylene to promote adhesion. For example, polyamides having relatively low melting points retain some level of crystallinity, but their low viscosity, high polarity and hydrogen bonding lends them useful for the purpose of the present invention. Polyolefins, preferably polar co- and ter-polymers such as ethylene-vinyl acetate copolymer (EVA) and ethylene butyl acrylate carbon monoxide terpolymer (EBACO), have proven useful to develop surface adhesion between a polyoxymethylene substrate and various surface treatments. Semi-crystalline polyesters generally comprise those with a melting point near or below that of polyacetal, such as, polycaprolactone or polylactic acid.

The non-acetal thermoplastic polymer can be incorporated into the composition as one thermoplastic polymer or as a blend of more than one thermoplastic polymer. Blends of the thermoplastic polymers may be used to adjust properties such as, for example, toughness or the compatibility of the major resin with the polyoxymethylene. Thermoplastic polyurethanes are typically used for this purpose. Preferably, however, the substrate comprises one additional or alternative polymer such as an amorphous thermoplastic polymer or semi-crystalline polymer.

Whether it is incorporated as one thermoplastic polymer or as a blend of more than one, the weight percent of all non-acetal thermoplastic polymer(s) in the composition shall not exceed the weight percent ranges given above.

The term “thermoplastic” shall mean the polymer softens, when heated, to a flowable state in which under pressure it can be forced or transferred from a heated cavity into a cool mold and upon cooling in the mold, it hardens and takes the shape of the mold. Thermoplastic polymers are defined in this manner in the Handbook of Plastics and Elastomers (published by McGraw-Hill).

The term “amorphous,” shall mean the polymer has no distinct crystalline melting point, nor does it have a measurable heat of fusion (although with very slow cooling from the melt, or with of sufficient annealing, some crystallinity may develop). The heat of fusion is conveniently determined on a differential scanning calorimeter (DSC). A suitable calorimeter is the DuPont Company's 990 thermal analyzer, Part Number 990000 with cell base II, Part Number 990315 and DSC cell, Part Number 900600. With this instrument, heat of fusion can be measured at a heating rate of 20° C. per minute. The sample is alternately heated to a temperature above the anticipated melting point and cooled rapidly by cooling the sample jacket with liquid nitrogen. The heat of fusion is determined on any heating cycle after the first and should be a constant value within experimental error. Amorphous polymers are defined herein as having a heat of fusion, by this method, of less than 1 cal/gram. For reference, semicrystalline 66 nylon polyamide with a molecular weight of about 17,000 has a heat of fusion of about 16 cal/gm.

The thermoplastic polymers useful in the present compositions must be melt processible at the temperature at which the polyoxymethylene is melt processed. Polyoxymethylene is normally melt processed at melt-temperatures of about 170° C.-260° C., preferably 185° C.-240° C., and most preferably 200° C.-230° C.

The term “melt processible” shall mean that the thermoplastic polymer must soften or have a sufficient flow such that it can be melt compounded at the particular melt processing temperature for the polyoxymethylene.

The minimum molecular weight of the thermoplastic polymer is not considered to be significant for the present blends, provided that the polymer has a degree of polymerization of at least ten and further provided that the polymer is melt processible (i.e., it flows under pressure) at the temperature at which the polyoxymethylene is melt processed. The maximum molecular weight of the thermoplastic polymer should not be so high that the thermoplastic polymer by itself would not be injection moldable by standard present techniques. The maximum molecular weight for a polymer to be used for injection molding processes will vary with each individual, particular thermoplastic polymer. However, said maximum molecular weight for use in injection molding processes is readily discernible by those skilled in the art.

To realize optimum physical properties for the ternary blend, it is recommended that the polyoxymethylene polymer and the non-acetal thermoplastic polymer have matching melt viscosity values under the same conditions of temperature and pressure.

Amorphous non-acetal thermoplastic polymers, which are injection molding and extrusion grade, suited for use in the blends of the present invention are well known in the art and can be selected from those commercially available or can be made by processes known in the art. Examples of such suitable amorphous thermoplastic polymers include, but are not limited to, those selected from the group consisting of styrene acrylonitrile copolymers (SAN), SAN copolymers toughened with a mostly unsaturated rubber, such as acrylonitrile-butadiene-styrene (ABS) resins, or toughened with a mostly saturated rubber, such as acrylonitrile-ethylene-propylene-styrene resins (AES), polycarbonates, polyamides, polyarylates, polyphenyleneoxides, polyphenylene ethers, high impact styrene resins (HIPS), acrylic polymers, imidized acrylic resins, styrene maleic anhydride copolymers, polysulfones, styrene acrylonitrile maleic anhydride resins, and styrene acrylic copolymers, and derivatives thereof and blends thereof. The preferred amorphous thermoplastic polymers are selected from the group consisting of styrene acrylonitrile copolymers (SAN), SAN copolymers toughened with a mostly unsaturated rubber, such as acrylonitrile-butadiene-styrene (ABS) resins, or toughened with a mostly saturated rubber, such as acrylonitrile-ethylene-propylene-styrene resins (AES), polycarbonates, polyamides, polyphenyleneoxides, polyphenylene ethers, high impact styrene resins (HIPS), acrylic polymers, styrene maleic anhydride copolymers, and polysulfones, and derivatives thereof and blends thereof. The more preferred amorphous thermoplastic polymers are selected from the group consisting of SAN, ABS, AES, polycarbonates, polyamides, HIPS, and acrylic polymers. Most preferred amorphous thermoplastic polymers are SAN copolymers, ABS resins, AES resins, and polycarbonates.

Amorphous thermoplastic SAN copolymers that are useful herein are well known in the art. SAN copolymer is generally a random, amorphous, linear copolymer produced by copolymerizing styrene and acrylonitrile. The preferred SAN copolymer has a minimum molecular weight of 10,000 and consists of 20-40% acrylonitrile, 60-80% styrene. The more preferred SAN copolymer consists of 25-35% acrylonitrile, 65-75% styrene. SAN copolymer is commercially available or it can be readily prepared by techniques well known to those skilled in the art. Amorphous thermoplastic SAN copolymers are further described on pages 214-216 in Engineering Plastics, volume 2, published by ASM INTERNATIONAL, Metals Park, Ohio (1988).

Amorphous thermoplastic ABS and AES resins, which are injection molding and extrusion grade resins, that are useful herein are well known in the art. ABS resin is produced by polymerizing acrylonitrile and styrene in the presence of butadiene, or a mostly butadiene, rubber. Preferably, the ABS resin is comprised of 50-95% of a matrix of SAN, with said matrix being comprised of 20-40% acrylonitrile and 60-80% styrene, and 5-50% of a butadiene rubber or a mostly butadiene rubber, such as styrene butadiene rubber (SBR). More preferably, it is comprised of 60-90% of a matrix of SAN, with said matrix more preferably being comprised of 25-35% acrylonitrile and 65-75% styrene, and 10-40% of a butadiene rubber. AES resin is produced by polymerizing acrylonitrile and styrene in the presence of a mostly saturated rubber. The preferred and more preferred AES resin is the same as the preferred and more preferred ABS resin except that the rubber component is comprised of mostly ethylene-propylene copolymer, as opposed to butadiene, or mostly butadiene, rubber. Other alpha-olefins and unsaturated moieties may be present in the ethylene-propylene copolymer rubber. Both ABS and AES copolymers are commercially available or can be readily prepared by techniques well known to those skilled in the art. Amorphous thermoplastic ABS resin is further described on pages 109-114 in Engineering Plastics, referenced above.

Amorphous thermoplastic polycarbonates that are useful herein are well known in the art and can be most basically defined as possessing the repetitive carbonate group —O—C(CO)—O— and in addition will always have the phenylene moiety attached to the carbonate group (cf. U.S. Pat. No. 3,070,563).

The present invention also contemplates the use of polycaprolactones and polylactic acids. Polycaprolactones are polymers of a cyclic ester. Preferably, a suitable polycaprolactone is one having a number average molecular weight of about 43,000 and a melt flow of 1.9g/10 minutes at 80C and 44 psi. Preferred polylactic acids are those having a melting point of about 155C,

Amorphous thermoplastic polycarbonates are commercially available or can be readily prepared by techniques well known to those skilled in the art. The most preferred aromatic polycarbonate on the basis of commercial availability and available technical information is the polycarbonate of bis(4-hydroxyphenyl)-2,2-propane, known as bisphenol-A polycarbonate. Amorphous thermoplastic polycarbonate is further described on pages 149-150 of Engineering Plastics, referenced above.

Amorphous or semi-crystalline thermoplastic polyamides that are useful herein are well known in the art. They are described in U.S. Pat. No. 4,410,661. Specifically, these amorphous or semi-crystalline thermoplastic polyamides are obtained from at least one aromatic dicarboxylic acid containing 8-18 carbon atoms and at least one diamine selected from the class consisting of:

(i) 2-12 carbon normal aliphatic straight-chain diamine,

(ii) 4-18 carbon branched aliphatic diamine, and

(iii) 8-20 carbon cycloaliphatic diamine containing at least one cycloaliphatic, preferably cyclohexyl, moiety, and wherein optionally, up to 50 weight percent of the polyamide may consist of units obtained from lactams or omega-aminoacids containing 4-12 carbon atoms, or from polymerization salts of aliphatic dicarboxylic acids containing 4-12 carbon atoms and aliphatic diamines containing 2-12 carbon atoms.

The term “aromatic dicarboxylic acid”, shall mean that the carboxy groups are attached directly to an aromatic ring, such as phenylene naphthalene, etc.

The term “aliphatic diamine”, shall mean that the amine groups are attached to a nonaromatic-containing chain such as alkylene.

The term “cycloaliphatic diamine”, shall mean that the amine groups are attached to a cycloaliphatic ring composed of 3-15 carbon atoms. The 6 or 12 carbon cycloaliphatic rings are preferred.

Preferred examples of thermoplastic polyamides include those with melting point less than about 180C, including co- and terpolymers of nylon 6, 610, 612 and the like.

The amorphous or semi-crystalline thermoplastic polyamides exhibit melt viscosities at 200° C. of less than 50,000 poise, preferably less than 20,000 poise measured at a shear stress of 105 dynes/cm². The amorphous or semi-crystalline polyamides are commercially available or can be prepared by known polymer condensation methods in the composition ratios mentioned above. In order to form high polymers, the total moles of the diacids employed should approximately equal the total moles of the diamines employed.

In addition free dicarboxylic acids, derivatives thereof, such as the chlorides, may be used to prepare the thermoplastic polyamide.

The polymerization to prepare the amorphous or semi-crystalline thermoplastic polyamides may be performed in accordance with known polymerization techniques, such as melt polymerization, solution polymerization and interfacial polymerization techniques, but it is preferred to conduct the polymerization in accordance with the melt polymerization procedure. This procedure produces polyamides having high molecular weights. In the polymerization, diamines and acids or cylic amides are mixed in such amounts that the ratio of the diamine components and the dicarboxylic acid components will be substantially equimolar. In melt polymerization the components are heated at temperatures higher than the melting point of the resulting polyamide but lower than the degradation temperature thereof. The heating temperature is in the range of about 170° C. to 300° C. The pressure can be in the range of vacuum to 300 psi. The method of addition of starting monomers is not critical. For example, salts of combinations of the diamines and acids can be made and mixed. It is also possible to disperse a mixture of the diamines in water, add a prescribed amount of a mixture of acids to the dispersion at an elevated temperature to form a solution of a mixture of nylon salts, and subject the solution to the polymerization.

If desired, a monovalent amine or, preferably, an organic acid, may be added as viscosity adjuster to a mixture of starting salts or an aqueous solution thereof.

Amorphous thermoplastic polyarylates that are useful herein are well known in the art and are described in detail in U.S. Pat. No. 4,861,828. Specifically, the amorphous thermoplastic polyarylates used in the compositions of the present invention are aromatic polyesters derived from at least one dihydric phenol or derivative thereof and at least one aromatic dicarboxylic acid or derivative thereof. Each component from which the amorphous thermoplastic polyarylate is derived has a functional group or groups, i.e., hydroxyl or carboxyl, attached directly to an aromatic ring. The dihydric phenol can be a bisphenol as described in U.S. Pat. No. 4,187,358 as structure 1: —HO—C₆H₃(—X)—OH.

Suitable examples of alkylene groups for X containing 1 to 5 carbon atoms include a methylene group, an ethylene group, a propylene group, a tetramethylene group and a pentamethylene group. Suitable examples of alkylidene groups for X containing 2 to 7 carbon atoms include an ethylidene group, a propylidene group, an isopropylidene group, an isobutylidene group, a pentylidene group, a cyclopentylidine group and a cyclohexylidine group. Suitable examples of alkyl groups of R₁ to R₄ and R_{1′} to R_{4′} containing 1 to 5 carbon atoms include a methyl group, an ethyl group, an isopropyl group, a tert-butyl group, and a neopentyl group.

Examples of suitable bisphenols are 4,4′-dihydroxy-diphenyl ether, bis(4-hydroxy-2-methylphenyl)ether, bis(4-hydroxy-3-chlorophenyl)-ether, bis(4-hydroxyphenyl)sulfide, bis(4-hydroxy-phenyl)sulfone, bis(4-hydroxyphenyl)ketone, bis(4-hydroxyphenyl)methane, bis(4-hydroxy-3,5-dichlorophenyl)-methane, 1,1-bis(4-hydroxyphenyl)-ethane, 2,2-bis(4-hydroxy-3-chlorophenyl)propane, 2,2-bis(4-hydroxy-3,5-dibromophenyl)propane, 3,3,3′,3′-tetramethyl spirobis-1,1′-indane-6,6′-diol and 1,1-bis(4-hydroxyphenyl)-n-butane. 2,2-Bis(4-hydroxyphenyl)propane, which is bisphenol A, is most preferred.

Typical examples of the functional derivatives of the bisphenol which can be used are the alkali metal salts and diesters with aliphatic monocarboxylic acid containing 1 to 3 carbon atoms. Suitable examples of aliphatic monocarboxylic acids include formic acid, acetic acid, propionic acid, etc. Preferred functional derivatives of the bisphenols are the sodium salts, the potassium salts, and the diacetate esters.

The bisphenol can be used either individually or as a mixture of two or more. Further, mixed salts or mixed carboxylate esters may be used.

Preferably, a mixture of 60 to 0 mole % of terephthalic acid and/or the functional derivatives thereof and 40 to 100 mole % of isophthalic acid and/or its functional derivatives is used as the acid component to be reacted with the bisphenol to prepare the polyarylate used in the compositions of the present invention. More preferably, a mixture of 0 to 50 mole % of terephthalic acid and/or the functional derivatives thereof and 100 to 50 mole % of isophthalic acid and/or the functional derivatives thereof is used. The molar ratio of the bisphenol to the sum of the terephthalic acid units and isophthalic acid units is substantially equimolar, e.g., about 1:0.95 to 1.2, preferably about 1:1, most preferably 1:1. Aromatic hydroxy acids such a hydroxy benzoic or hydroxy naphthoic acid and other dicarboxylic acids (both aromatic and aliphatic) can also be incorporated into the polyarylate structure as a minor component.

Examples of functional derivatives of terephthalic or isophthalic acid which can be used in this invention include acid halides and diaryl esters. Preferred examples of acid halides include terephthaloyl dichloride, isophthaloyl dichloride, terephthaloyl dibromide and isophthaloyl dibromide. Preferred examples of diaryl esters include diphenyl terephthalate and diphenyl isophthalate.

In the preparation of the amorphous thermoplastic polyarylate, at most 50 mole %, preferably at most 25 mole %, of a compound having a carbonate linkage such as diphenyl carbonate or an aliphatic glycol such as ethylene glycol, propylene glycol, tetramethylene glycol or neopentyl glycol may also be copolymerized therewith to improve the molding characteristics. To change the reactivity and possibly the stability of the polyarylate, monofunctional components can be included in the polyarylate to limit molecular weight or reduce the proportions of reactive ends.

Amorphous thermoplastic polyarylates useful in the compositions of the present invention are commercially available or can be prepared by any of several known methods. The interfacial polymerization method comprises mixing a solution of an aromatic dicarboxylic acid chloride in a water-immiscible organic solvent with an alkaline aqueous solution of bisphenol. The solution polymerization method comprises heating bisphenol and a diacid dichloride in an organic solvent. One melt polymerization method comprises heating a diphenyl ester or an aromatic dicarboxylic acid and bisphenol. An alternate melt polymerization method comprises heating aromatic dicarboxylic acid and a diester (e.g., the diacetate ester) of bisphenol. These methods are described in detail in U.S. Pat. Nos. 3,884,990, 3,946,091, 4,052,481 and 4,485,230.

Amorphous thermoplastic polyphenylene ethers (PPE) and polyphenylene oxides (PPO) that are useful herein are known in the art. PPE homopolymer is frequently referred to as PPO. The chemical composition of the homopolymer is poly(2,6-dimethyl4,4-phenylene ether) or poly(oxy-(2-6-dimethyl-4,4-phenylene)): —C₆H₂(—CH₃)₂—O— The chemical composition of PPE, which is a copolymer. PPE and PPO are further described on pages 183-185 in Engineering Plastics, referenced above. Both PPE and PPO are commercially available or can be readily prepared by known techniques by those skilled in the art. They are typically marketed as blends with polystyrene due to their high melt viscosity.

Amorphous thermoplastic high impact styrene (HIPS) resins that are useful herein are well known in the art. HIPS is produced by dissolving usually less than 20 percent polybutadiene rubber, or other unsaturated rubber, in styrene monomer before initiating the polymerization reaction. Polystyrene forms the continuous phase of the polymer and the rubber phase exists as discrete particles having occlusions of polystyrene. HIPS resin is further described on pages 194-199 in Engineering Plastics, referenced above. HIPS resins are commercially available or can be readily prepared from known techniques by those skilled in the art.

Amorphous thermoplastic polymers of acrylics, which are extrusion and injection molding grade, that are useful herein are well known in the art. Amorphous thermoplastic acrylic polymers comprise a broad array of polymers in which the major monomeric constituents belong to two families of ester-acrylates and methacrylates. Amorphous thermoplastic acrylic polymers are described on pages 103-108 in Engineering Plastics, referenced above. The molecular weight of the amorphous thermoplastic polymer of acrylics, for it to be injection moldable by standard present techniques, should not be greater than 200,000. Amorphous thermoplastic acrylic polymers are commercially available or can be readily prepared from known techniques by those skilled in the art.

Amorphous thermoplastic imidized acrylic resins that are useful herein are well known in the art. Amorphous thermoplastic imidized acrylic resins are prepared by reacting ammonia, or a primary amine, with an acrylic polymer, such as polymethyl methacrylate, to form the imidized acrylic resin (also known as polyglutarimides).

The imidized acrylic resin will contain at least about 10% imide groups and preferably at least about 40% imide groups, and can be prepared as described, for example, in U.S. Pat. No. 4,246,374 and in U.K. Patent 2101139B. Representative imide polymers include imidized poly(methyl methacrylate) or poly(methyl acrylate), imidized copolymers of either methyl methacrylate or methyl acrylate and comonomers such as butadiene, styrene, ethylene, methacrylic acid, or the like.

Amorphous thermoplastic imidized acrylic resins are also described in U.S. Pat. No. 4,874,817. Amorphous thermoplastic imidized acrylics are commercially available or can be readily prepared from known techniques by those skilled in the art.

Amorphous thermoplastic copolymers of styrene maleic anhydride that are useful herein are well known in the art. Styrene maleic anhydride copolymers are produced by the reaction of styrene monomer with smaller amounts of maleic anhydride. Amorphous thermoplastic styrene maleic anhydride copolymers are further described on pages 217-221 in Engineering Plastics, referenced above. They are commercially available or can be prepared from known techniques by those skilled in the art.

Amorphous thermoplastic polysulfones that are useful herein are well known in the art. It is produced from bisphenol A and 4,4′-dichlorodiphenylsulfone by nucleophilic displacement chemistry. It is further described on pages 200-202 in Engineering Plastics, referenced above. Polysulfone is commercially available or can be readily prepared from known techniques by those skilled in the art.

Amorphous thermoplastic styrene acrylonitrile maleic anhydride copolymers and styrene acrylic copolymers that are useful herein are known in the art. They are commercially available or can be prepared from known techniques by those skilled in the art.

The amorphous or semi-crystalline thermoplastic polymers may also contain those additional ingredients, modifiers, stabilizers, and additives commonly included in such polymers.

The thermoplastic polyurethanes suited for use in the blends of the present invention can be selected from those commercially available or can be made by processes known in the art. (See, for example, Rubber Technology, 2nd edition, edited by Maurice Morton (1973), Chapter 17, Urethane Elastomers, D. A. Meyer, especially pp. 453-6). Thermoplastic polyurethanes are derived from the reaction of polyester or polyether polyols with diisocyanates and optionally also from the further reaction of such components with chain-extending agents such as low molecular weight polyols, preferably diols, or with diamines to form urea linkages. Thermoplastic polyurethanes are generally composed of soft segments, for example polyether or polyester polyols, and hard segments, usually derived from the reaction of the low molecular weight diols and diisocyanates. While a thermoplastic polyurethane with no hard segments can be used, those most useful will contain both soft and hard segments.

In the preparation of the thermoplastic polyurethanes useful in the blends of the present invention, a polymeric soft segment material having at least about 500 and preferably from about 550 to about 5,000 and most preferably from about 1,000 to about 3,000, such as a dihydric polyester or a polyalkylene ether diol, is reacted with an organic diisocyanate in a ratio such that a substantially linear polyurethane polymer results, although some branching can be present. A diol chain extender having a molecular weight less than about 250 may also be incorporated. The mole ratio of isocyanate to hydroxyl in the polymer is preferably from about 0.95 to 1.08 more preferably 0.95 to 1.05, and most preferably, 0.95 to 1.00. In addition, monofunctional isocyanates or alcohols can be used to control molecular weight of the polyurethane.

Suitable polyester polyols include the polyesterification products of one or more dihydric alcohols with one or more dicarboxylic acids. Suitable polyester polyols also include polycarbonate polyols. Suitable dicarboxylic acids include adipic acid, succinic acid, sebacic acid, suberic acid, methyladipic acid, glutaric acid, pimelic acid, azelaic acid, thiodipropionic acid and citraconic acid and mixtures thereof, including small amounts of aromatic dicarboxylic acids. Suitable dihydric alcohols include ethylene glycol, 1,3- or 1,2-propylene glycol, 1,4-butanediol, 1,3-butanediol, 2-methylpentanediol-1,5, diethylene glycol, 1,5-pentanediol, 1,5-hexanediol, 1,2-dodecanediol, and mixtures thereof.

Further, hydroxycarboxylic acids, lactones, and cyclic carbonates, such as epsilon-caprolactone and 3-hydroxybutyric acid can be used in the preparation of the polyester.

Preferred polyesters include poly(ethylene adipate), poly(1,4-butylene adipate), mixtures of these adipates, and poly epsilon.-caprolactone.

Suitable polyether polyols include the condensation products of one or more alkylene oxides with a small amount of one or more compounds having active hydrogen containing groups, such as water, ethylene glycol, 1,2- or 1,3-propylene glycol, 1,4-butanediol and 1,5-pentanediol and mixtures thereof. Suitable alkylene oxide condensates include those of ethylene oxide, propylene oxide and butylene oxide and mixtures thereof. Suitable polyalkylene ether glycols may also be prepared from tetrahydrofuran. In addition, suitable polyether polyols can contain comonomers, especially as random or block comonomers, ether glycols derived from ethylene oxide, 1,2-propylene oxide and/or tetrahydrofuran (THF). Alternatively, a THF polyether copolymer with minor amounts of 3-methyl THF can also be used.

Preferred polyethers include poly(tetramethylene ether) glycol (PTMEG), poly(propylene oxide) glycol, and copolymers of propylene oxide and ethylene oxide, and copolymers of tetrahydrofuran and ethylene oxide. Other suitable polymeric diols include those which are primarily hydrocarbon in nature, e.g., polybutadiene diol.

Suitable organic diisocyanates include 1,4-butylene diisocyanate, 1,6-hexamethylene diisocyanate, cyclopentylene-1,3-diisocyanate, 4,4′-dicyclohexylmethane diisocyanate, isophorone diisocyanate, cyclohexylene-1,4-diisocyanate, 2,4-toluene diisocyanate, 2,6-toluene diisocyanate, isomeric mixtures of 2,4- and 2,6-toluene diisocyanate, 4,4′-methylene bis(phenylisocyanate ),2,2-diphenylpropane-4,4′-diisocyanate, p-phenylene diisocyanate, m-phenylene diisocyanate, xylene diisocyanate, 1,4-naphthylene diisocyanate, 1,5-naphthylene diisocyanate, 4,4′-diphenyl diisocyanate, azobenzene-4,4′-diisocyanate, m- or p-tetramethylxylene diisocyanate, and 1-chlorobenzene-2,4-diisocyanate. 4,4′-methylene bis(phenylisocyanate), 1,6-hexamethylene diisocyanate, 4,4′-dicyclohexylmethane diisocyanate and 2,4-toluene diisocyanate are preferred.

Secondary amide linkages including those derived from adipyl chloride and piperazine, and secondary urethane linkages, including those derived from the bis-chloroformates of PTMEG and/or butanediol, can also be present in the polyurethanes.

Dihydric alcohols suitable for use as chain extending agents in the preparation of the thermoplastic polyurethanes include those containing carbon chains which are either uninterrupted or which are interrupted by oxygen or sulfur linkages, including 1,2-ethanediol, 1,2-propanediol, isopropyl-a-glyceryl ether, 1,3-propanediol, 1,3-butanediol, 2,2-dimethyl-1,3-propanediol, 2,2-diethyl-1,3-propanediol, 2-ethyl-2-butyl-1,3-propanediol, 2-methyl-2,4-pentanediol, 2,2,4-trimethyl-1,3-pentanediol, 2-ethyl-1,3-hexanediol, 1,4-butanediol, 2,5-hexanediol, 1,5-pentanediol, dihydroxycyclopentane, 1,6-hexanediol, 1,4-cyclohexanediol, 4,4′-cyclohexanedimethylol, thiodiglycol, diethylene glycol, dipropylene glycol, 2-methyl-1,3-propanediol, 2-methyl-2-ethyl-1,3-propanediol, dihydroxyethyl ether of hydroquinone, hydrogenated bisphenol A, dihydroxyethyl terephthalate and dihydroxymethyl benzene and mixtures thereof. Hydroxyl terminated oligomers of 1,4-butanediol terephthalate can also be used, giving a polyester-urethane-polyester repeating structure. Diamines can also be used as chain extending agents giving urea linkages. 1,4-butanediol, 1,2-ethanediol and 1,6-hexanediol are preferred.

In the preparation of the thermoplastic polyurethanes, the ratio of isocyanate to hydroxyl should be close to unity, and the reaction can be a one step or a two step reaction. Catalysts can be used, and the reaction can be run neat or in a solvent.

The moisture content of the blend, in particular of the thermoplastic polyurethane, can influence the results achieved. Water is known to react with polyurethanes, causing the polyurethane to degrade, thereby lowering the effective molecular weight of the polyurethane and lowering the inherent and melt viscosity of the polyurethane. Accordingly, the drier the better. In any event, the moisture content of the blend, and of the individual components of the blend, should contain less than 0.2 percent by weight of water, preferably less than 0.1 percent, especially when there is no opportunity for the water to escape, for example during an injection molding process and other techniques of melt processing. The thermoplastic polyurethane can also contain those additives, ingredients, and modifiers known to be added to thermoplastic polyurethane. It is noted here that the addition of any of styrene acrylonitrile copolymers, acrylonitrile-butadiene-styrene copolymers, acrylonitrile-ethylene-butadiene-styrene copolymers, and polycarbonates to polyoxymethylene alone reduces the mold shrinkage of the polyoxymethylene.

Additional Layer Component

Generally the substrate of the present invention may be coated with paints or overmolded with thermoplastic elastomers, glues and the like such these are the at least one layer adhered to the substrate. The adhesion is promoted due to the presence and distribution of the at least one amorphous or semi-crystalline thermoplastic component or polymer on or near the surface of the mostly polyacetal substrate as described above.

Examples of suitable materials for overmolding include, but are not limited to, both polar and non-polar materials. Such non-polar materials include, but are not limited to, thermoplastic olefins (TPO), Kraton®, thermoplastic elastomers (TPE-S), polyethylene and polypropylene. Such polar materials include, but are not limited to, thermoplastic polyurethanes (TPU), Surlyn®, Hytrel® and polar olefins.

Examples of suitable materials for printing/painting may include solvents, water latex, epoxy, urethane, powder coating acrylic paints or inks and the like.

Examples of suitable materials for gluing includes solvent-based glues, latex, epoxy, super glue and the like.

Generally, the at least one adhered layer of the present invention may be either co-continuous or discontinuous.

Various conventional methods may be used to adhere the at least one additional layer to the substrate including, but not limited to, wet painting, powder coating, two-shot molding, insert molding, co-extrusion, gluing and metalizing.

Wet painting methods utilize either water-based or solvent-based paints that are applied via those methods known in the art such as spraying, brushing and the like.

Powder coating methods that are well known in the art, such as, for example, dipping in a fluidized bed or electrostatic fluidized beds or electrostatic spraying use a finely divided, dry solid resinous powder that may be a paint or another plastic and can be deposited on the surface of the substrate and then cured/molten at elevated temperatures.

Two-shot molding methods are well known in the art and are typically carried out wherein one part of a cavity is filled with substrate material out of a first barrel of the 2-shot injection molding machine, then the mould opens and rotates or sliders open to modify the cavity and after closing the mold again, this new cavity is filled with layer material from a second barrel.

Insert molding methods are well known in the art and may utilize conventional molding machines, wherein the molded parts are then inserted, either manually or automatically, into another mold where the layer material is molded “on top” or around the substrate (this technique requires that the part is ejected from the mold between the 2 steps; in the method above, the part is not ejected between the 2 shots.

Co-extrusion methods, well known to those skilled in the art, allow for the extrusion of films, sheets, profiles, tubing, wire coatings and extrusion coatings.

Gluing may be performed by any method known in the art, including manual and/or mechanical methods.

Metalizing methods include those well known in the art, such as, for example, electroplating including, but not limited to, chrome plating wherein the process utilizes a mixture of chemical and electrochemical methods for the deposition of various layers.

Method of Preparation of the Articles

The present invention further relates to a process for making the above-noted article comprising the steps of:

(i) blending a matrix comprising 99.55-40 weight percent of an polyoxymethylene polymer and 0.5-60 weight percent of at least one thermoplastic polymer; and

(ii) molding the matrix into a substrate; and

(iii) adhering at least one layer to said substrate.

The matrix may be blended using any conventionally known machine. Preferably, however, the matrix is blended using a co-rotating twin screw extruder.

The substrate may be molded according to those principals known in the art utilizing any of the conventionally known processes, for example, extrusion, co-extrusion, two-shot molding, insert molding and the like.

Adhering the at least one additional layer to the substrate may be performed according to any of the known methods, as are described above.

### EXAMPLES

The present invention is further defined in the following Examples, in which all parts and percentages are by weight. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usage and conditions.

Generally, the adhesion was determined using a peel test in the case of thermoplastic elastomer layers, while the level of adhesiveness of the paint/printing layers was determined using a cross-hatch paint adhesion test.

Typically, “peel” is the imposition of a tensile stress in a direction that is perpendicular to the adhesive bond line (the line where the materials are united by the adhesive). Moreover, the “peel strength” indicates the strength of an adhesive, and is defined as the average force per unit test specimen width measured along the bond line required to separate progressively of the of the bonded test specimen and is described as pounds per inch of width (having a metric equivalent of Newtons per millimeter).

Various embodiments of the present invention made utilizing either two shot molding methods or insert injection molding methods were tested to assess the peel strength of the overmolding. Those samples made using these molding methods were peel tested using a L-type peel test (commonly referred to as a 90 degree peel test) on a conventional standard tensile testing machine, such as, an Instron tensile testing machine. Typical samples comprised a substrate having a length of about 6 inches, a thickness of about ⅛ inches, and a width of about 1 inch. The additional layer adhered to the substrate had a width of about 1 inch and a thickness of about ⅛ inches. Additionally, either a length of the adhered layer extended a distance past the end of the substrate or a portion of the end of the specimen is pulled up, such that a portion of the layer is not in contact with the substrate to allow its attachment to the tensile machine.

Generally the method comprises having a substrate and the adhered layer, in a fixed position on a horizontally movable sample holder (e.g. a sled, wheels or roller). The extended end portion of the adhered layer is clamped to the upper traverse of the tensile machine so that there is a 90 degree angle between the substrate and the additional layer being peeled. The traverse moves upwards and peels off the additional layer; the sample holder for the substrate moves horizontally as the traverse moves vertically to keep the peel angle constant. As the traverse begins to peel the adhered layer away from the material, the adhesion factor is progressively measured.

Typically, the cross-hatch adhesion test (DIN EN IS02409 as well as a modified version of ASTM-D3359-83, Method B) was conducted, such that a substrate was formed and subsequently coated with a paint. One hundred small squares (about 1/16 inches×1/16 inches) were cut into the adhered layer by making two cuts with a bladed device (e.g. Gardco® Model P-A-T Cutter Blades, manufactured by Gardco Corporation, at a 90 degree angle. The depth of the cuts was carefully monitored so as to ensure that the cuts penetrated only the adhered layer and did not extend to any significant depths into the substrate. A quantity of suitable tape, for example Permacel 99 Tape (manufactured by Permacel Corporation, New Brunswick, N.J.), was then applied over the area cut into squares on the coated substrate so the entire area being assessed was covered. The tape was then removed and the degree of flaking of the paint due to the tape removal was assessed. A modification to the ASTM D 3359 test was made in the classification of the adhesion test results. The tests according to the present invention used a value of “0” to classify those samples in which no flaking had occurred (i.e. even at the razor cut edges), and thus showed the greatest level of adhesion, while a value of “5” was assigned in those instances where flaking of greater than 65% had been found, thus, no other aspects of the test were modified.

### Example 1

Paint Adhered to High Polyoxymethylene-content Substrates

Table 1 sets forth the compositions of the various types of substrates used in the Examples. Each substrate was painted with a single paint, either paint I or paint K, the cross-hatch test was performed and the results evaluated. The cross-hatch test results are also shown in Table 1. Sample 1 represents the control and samples 2-8 are examples of the present invention.

The Control substrate was a substrate (Sample Type 1) comprising 100% of a polyacetal homopolymer (MW=38,000). This Control substrate was painted with Paint I to form the adhered layer and tested according to the cross-hatch test described herein. When the tape was applied and subsequently removed, a value of 2 was assessed, thereby showing a moderate level of adhesion. A second test and a third test each using a Sample Type 1 substrate were painted with Paint K and again subjected to the cross-hatch test described herein, wherein values of 2 and 3 were assessed, respectively.

Sample Type 2 was a substrate comprising 90% of a polyacetal homopolymer (MW=38,000) and 10% of a thermoplastic polyurethane with ethylene adipate soft segment and 4,4′ methylene bisphenyl isocyanate. The adhered layer applied to the substrate was paint K, which when tested according to the cross-hatch test, resulted in an adhesion level of 1.

Sample Type 3 was a substrate comprising 90% of a polyacetal homopolymer (MW=38,000) and 10% of a polycaprolactone (MW=43,000). The adhered layer applied to the substrate was paint K, which when tested according to the cross-hatch test, resulted in an adhesion level of 0, meaning no flaking occurred.

Sample Type 4 was a substrate comprising 90% of a polyacetal homopolymer (MW=38,000) and 10% of a polylactic acid (having a melting point of 155° C. The adhered layer applied to the substrate was paint K, which when tested according to the cross-hatch test, resulted in an adhesion level of 1.

Sample Type 5 was a substrate comprising 90% of a polyacetal homopolymer (MW=38,000) and 10% of a thermoplastic polyurethane with butylene adipate soft segments and 4,4′ methylene bisphenyl isocyanate. The adhered layer applied to the substrate was paint K, which when tested according to the cross-hatch test, resulted in an adhesion level of 0. The second test was run using another substrate having the composition of Sample Type 5, where the adhered layer was paint K, thereby resulting in an adhesion level of 2. A third test was run utilizing a substrate of Sample Type 5, wherein paint I was adhered to the substrate, and an adhesion level of 1 resulted.

Sample Type 6 was a substrate comprising 90% of a polyacetal homopolymer (MW=65,000) and 1% of a polyacetal copolymer with 4.5% ethylene oxide groups (Mn=22,000); 1% of a thermoplastic polyurethane with butylenes adipate soft segments and 4,4′ methylene bisphenyl isocyanate; and 8% of a nylon 66/610/6 having a melting point of 154° C. (Mn=40,000). The layer adhered to the substrate was paint K, which when tested according to the cross-hatch test, resulted in an adhesion level of 0. A second test was run using another substrate having the composition of Sample Type 6, where the adhered layer was again paint K, resulting in an adhesion level of 0. A third test was run utilizing a substrate of Sample Type 6, wherein paint I was adhered to the substrate, and an adhesion level of 4 resulted. In this Sample as well as in sample types 7 and 8, paint I shows a reduction in adhesion in comparison to paint K. This is believed to be the result of the different interaction of paint I with the additives used in the respective examples. Thus, the applier would need to take this into account.

Sample Type 7 was a substrate comprising 90% of a polyacetal homopolymer (MW=65,000) and 1% of a polyacetal copolymer with 4.5% ethylene oxide groups (Mn=22,000); 1% of a thermoplastic polyurethane with butylene adipate soft segments and 4,4′ methylene bisphenyl isocyanate; and 8% of a nylon 66/610/612/6 having a melting point of 116° C. (Mn=18,000). The layer adhered to the substrate was paint K, which when first tested according to the cross-hatch test, resulted in an adhesion level of 0. A second test was run using another substrate having the composition of Sample Type 7, where the adhered layer was paint K, resulting in an adhesion level of 1. A third test was run utilizing a substrate of Sample Type 7, wherein paint I was adhered to the substrate, and an adhesion level of 3 resulted.

Sample Type 8 was a substrate comprising 90% of a polyacetal homopolymer (MW=65,000) and 1% of a polyacetal copolymer with 4.5% ethylene oxide groups (Mn=22,000); 1% of a thermoplastic polyurethane with butylene adipate soft segments and 4,4′ methylene bisphenyl isocyanate; and 8% of a thermoplastic polyester poly ether elastomer containing 41% PBT hard segment/59% ethylene oxide-polypropylene oxide soft segment. The layer adhered to the substrate in the first run was paint K, which when tested according to the cross-hatch test, resulted in an adhesion level of 1. A second test was run using another substrate having the composition of Sample Type 8, where the adhered layer was, again, paint K, resulting in an adhesion level of 0. A third test was run utilizing a substrate of Sample Type 8, wherein paint I was adhered to the substrate, and an adhesion level of 4 resulted.

Table 1.

TABLE 1

| Sample | | % Non- | | | |
|---|---|---|---|---|---|
| Type | % POM | acetal | % Other | I | K |
| 1 | 100 | — | — | 2 | 2.3 |
| 2 | 90 | 10 | — | | 1 |
| 3 | 90 | 10 | — | | 0 |
| 4 | 90 | 10 | — | | 1 |
| 5 | 90 | 10 | — | 1 | 0.2 |
| 6 | 90 | — | 10 | 4 | 0.0 |
| 7 | 90 | — | 10 | 3 | 0.1 |
| 8 | 90 | — | 10 | 4 | 1.0 |

Paint I=a spray enamel 1244 metallic gold paint (manufactured by Testor Corporation)

Paint K=TS-5 Olive Drab paint (manufactured by Tamiya Europe GMBH),

### Example 2

Paint Adhered to Low Polyoxymethylene-content Substrates

In Table 2, the various types of substrates used in this Example are shown. The results of the cross-hatch tests for adhesion is provided in Table 3. Descriptions of the paints used are also provided below. Each substrate was painted with only one type of paint, thus, each substrate had a single layer of paint adhered to it.

Sample Type 9 designated substrates comprising 100% of a polyacetal homopolymer (MW=65,000). Two substrates of Sample Type 9, were used, wherein the adhered layers tested with this type of substrate were paints B and F.

Sample Type 10, designated substrates comprising 100% of a polyacetal homopolymer (MW=38,000). Various substrates of this type were tested, wherein the layer adhered to each was one of paints F, G, H, I, J, K, L, M, N, P, Q, R, S, T, and U.

Sample Type 11 designated substrates comprising 100% of a nucleated polyacetal homopolymer (MW=38,000). A substrate of this type was painted with paint B to form the adhered layer.

Sample Type 12 designated substrates comprising 60% of a polyacetal homopolymer (MW=65,000); 10% of a thermoplastic polyurethane with butylene adipate soft segments and 4,4′ methylene bisphenyl isocyanate; and10% of an extrusion grade ABS (melt flow=3.9) and 20% of a styrene acrylonitrile copolymer (melt flow=25g/10 minutes with 3.8 Kg weight at 445° F. Two substrates of this type were painted, one using paint B and the other using paint F to form the adhered layer.

Sample Type 13 designated substrates comprising 55% of a polyacetal homopolymer (MW=38,000); 15% of a thermoplastic polyurethane with butylene adipate soft segments and 4,4′ methylene bisphenyl isocyanate; and 30% of an extrusion grade ABS (melt flow=3.9). The layer adhered to the substrates of this type that were used were one of paints B, F, G, H, I, J, K, L, M, N, P, Q, R, S, T, or U.

Sample Type 14 designated substrates comprising 55% of a polyacetal homopolymer (MW=38,000) and 15% of a thermoplastic polyurethane with ethylene adipate soft segments and 4,4′ methylene bisphenyl isocyanate; and 30% of an extrusion grade ABS (melt flow=3.9). The layer adhered to the substrate in this Example was paint F.

Sample Type 15 designated substrates comprising 55% of a polyacetal copolymer with 4.5% ethylene oxide groups (Mn=22,000); 15% of a thermoplastic polyurethane with butylene adipate soft segments and 4.4′ methylene bisphenyl isocyanate; and 30% of an extrusion grade ABS (melt flow=3.9). Two substrates of this type were tested, wherein the layer adhered to the each substrate was either paint F or K.

Sample Type 16 designated substrates comprising 55% of a polyacetal copolymer with 1.4% ethylene oxide groups (Mn=20,800); 15% of a thermoplastic polyurethane with butylene adipate soft segments and 4,4′ methylene bisphenyl isocyanate; and 30% of an extrusion grade ABS (melt flow=3.9). A single substrate was tested having paint K as the adhered layer.

Sample 17 designated substrates comprising 55% of a polyacetal homopolymer (MW=38,000); 5% of a thermoplastic polyurethane with butylene adipate soft segments and 4,4′ methylene bisphenyl isocyanate; 10% of precipitated CaCO3 with a particle size of 0.7 microns and a coating of 2% stearic acid; and 30% of an extrusion grade ABS (melt flow=3.9). The layer adhered to the substrate was paint F.

TABLE 2

| Sample | | % Non- | |
|---|---|---|---|
| Type | % POM | acetal | % Other |
| 9 | 100 | — | — |
| 10 | 100 | — | — |
| 11 | 100 | — | — |
| 12 | 60 | 10 | 10 + 20 |
| 13 | 55 | 15 | 30 |
| 14 | 55 | 15 | 30 |
| 15 | 55 | 15 | 30 |
| 16 | 55 | 15 | 30 |
| 17 | 55 | 5 | 10 + 30 |

TABLE 3

| Sample | Adhered Paint Layer | | | | | | | | | | | | | | | |
|---|---|---|---|---|---|---|---|---|---|---|---|---|---|---|---|---|
| Type | B | F | G | H | I | J | K | L | M | N | P | Q | R | S | T | U |
| 9 | 5 | 5 | | | | | | | | | | | | | | |
| 10 | | 5 | 5 | 4 | 2 | 4 | 2.3 | 5 | 5 | 5 | 5 | 5 | 4 | 5 | 4 | 5 |
| 11 | 5 | | | | | | | | | | | | | | | |
| 12 | 2 | 0 | | | | | | | | | | | | | | |
| 13 | | 0 | 0 | 0 | 0 | 1 | 0.0 | 0 | 0 | 0 | 0 | 0 | 0 | 0 | 0 | 0 |
| 14 | | 0 | | | | | | | | | | | | | | |
| 15 | | 0 | | | | | 0 | | | | | | | | | |
| 16 | | | | | | | 0 | | | | | | | | | |
| 17 | | 0 | | | | | | | | | | | | | | |

Paint Key:

B=Rust-oleum Hard Hat, spray, finish ACABADO safety blue V2124.

F=Aervoe-Pacific Rust Proofing Paint, spray, 303 gloss safety blue, xylene, acetone, mineral spirits, ethyl benzene.

G=spray enamel, pactra Racing Finish, RC287 bright red, for PC. (manufactured by Testor Corporation).

H=spray enamel, 1224 gloss green, petroleum distillates, liquified petroleum propellant (manufactured by Testor Corporation).

I=spray enamel, 1244 metallic gold, alcohols, toluene, petroleum propellant (manufactured by Testor Corporation).

J=spray enamel, 130030 Reffer Orange, hydrocarbon propellants, petroleum distallants, ketones & ester solvent (manufactured by Testor Corporation).

K=TS-5 Olive Drab (manufactured by Tamiya Europe GMBH).

L=Plasti-kote Trim Black 611, acetone, Xylene.

M=Plasti-kote Classic Lacquer 346 bright red.

N=Plasti-kote Flexible Bumper & Trim, 1892 light grey primer, acetone, zylene, toluene.

Each of the above listed paints were aerosol spray paints. However, these paints were used as examples and does not limit the present invention to the use of aerosol spray paints.

### Example 3

Glue

In Control Samples 18-21, identical tensile bars of PVC having a length of about 6 inches and a thickness of about ⅛ inches were punched from a sheet of commercially purchased PVC. One tab was cut off and the narrow central portions were glued to each other in a lap shear fashion such that there was an overlap of the samples of about 1-inch. Samples 18-21 did not utilize any primer prior to being glued. Except for the unglued Sample, all Samples were lightly sanded prior to gluing using a fine grit sandpaper until the glossy surface was destroyed. After gluing, all the Samples were clamped using a C-clamp for a period of 24 hours.

The Control Samples gluing polyoxymethylene to polyoxymethylene and polyoxymethylene to PVC resulted in such weak adhesion they could not be tested. These samples broke while being clamped into the Instron test machine, due to the lack of adhesion.

Samples 22-26 comprise 55% of polyacetal homopolymer (MW=65,000);15% of a thermoplastic polyurethane with butylene adipate soft segments and 4,4′ methylene bisphenyl isocyanate; and 30% of an extrusion grade ABS (melt flow=2.5). These Samples, when tested, were pulled at 0.2 inches/minute and were constrained from twisting by a loose sleeve during the pulling.

TABLE 4

| | | | Stress (max, | Strain |
|---|---|---|---|---|
| Sample | Glue | Primer | Kpsi) | at break |
| 18 (Control) | None | None | 8.4 | 54.9 |
| 19 (Control) | Type B | None | 6.0 | 5.6 |
| 20 (Control) | Type C | None | 4.2 | 2.5 |
| 21 (Control) | Type D | None | 5.8 | 4.1 |
| 22 | Type B | Type P | 5.3 | 31.0 |
| 23 | Type C | Type C | 5.9 | 40.1 |
| 24 | Type D | None | 5.0 | 4.0 |
| 25 | Type D | Type C | 5.6 | 30.2 |
| 26 | Type D | Type P | 5.8 | 39.0 |
| 27 | Type D | Type P | 5.8 | 37.6 |

Glue:

Type B—Harvey's MP-6, #01800, Multipurpose -ABS, PVC., CPVC (manufactured by William H. Harvey Co., Omaha NE).

Type C—IPS Weld-on PVC 700, #10082 (manufactured by IPS Corporation, Gardinia, Calif.).

Type D—Oaty #31128 CPVC Cement (manufactured by Oaty Corporation, Cleveland, Ohio.

Primers:

Type C—IP Weld-on C-65 Cleaner-PVC., CPVC., ABS, Styrene #10204 (manufactured by IPS Corporation, Gardinia, Calif.).

Type P—Harvey's Purple Primer-PVC., CPVC (manufactured by William H.Harvey Co., Omaha Neb.).

### Example 4

Overmolding

Sample Types 28-36 were substrates that had been molded in a plaque mold (⅛ inches×4 inches×6 inches). These substrates were then inserted into a ¼ inch deep mold of the same length and width dimensions to be inserted molded by the thermoplastic elastomers set forth in Tables 5, 6 and 7. The substrates having the adhered layer were tested according to the peel test described above. Subsequently, several of those substrates were tested a second time on a different tensile machine at a different location. The first location utilized an Instron Model 4202 (Instron Corporation, New Ulm, Minn.) and the second location utilized a Zwick Model Z2.5 (Zwick GMBH).

Sample Type 28 is a substrate comprising 100% of a polyacetal homopolymer (MW=38,000).

Sample Type 29 is a substrate comprising 90% of a polyacetal homopolymer (MW=38,000); and 10% of a thermoplastic polyurethane with butylene adipate soft segments and 4,4′ methylene bisphenyl isocyanate.

Sample Type 30 is a substrate comprising 70% of a polyacetal homopolymer (MW=65,000); and 30% of a thermoplastic polyurethane with butylene adipate soft segments and 4,4′ methylene bisphenyl isocyanate.

Sample Type 31 is a substrate comprising 95% of a nucleated polyacetal homopolymer (MW=65,000); and 5% of an ethylene vinyl acetate copolymer (with 40% vinyl acetate) having a melt index of 55.

Sample Type 32 is a substrate comprising 90% of a polyacetal copolymer with 1.3% ethylene oxide groups (Mn=28,300); and 10% of a phenol-formaldehyde thermoplastic resin (Mn=1000 and Tg=80° C.).

Sample Type 33 is a substrate comprising 80% of a polyacetal homopolymer (MW=38,000); and 20% of a high impact polystyrene (melt flow=3.5g/10 minutes with 5.0 Kg weight at 200° C., ASTM D1238).

Sample Type 34 is a substrate comprising 90% of a polyacetal copolymer with 1.3% ethylene oxide groups (Mn=28,300); and 10% of a zinc ionomer of 67% ethylene/24% n-butyl acrylate/9% methacrylic acid (melt index=25).

Sample Type 35 is a substrate comprising 50% of a polyacetal homopolymer (MW=38,000); 20% of a butylene adipate soft segments and 4,4′ methylene bisphenyl isocyanate; and 30% of a styrene acrylonitrile copolymer (melt flow=25g/10 minutes with 3.8 Kg weight at 445° C.

Sample Type 36 is a substrate comprising 55% of a polyacetal homopolymer (MW=38,000); 15% of a thermoplastic polyurethane with butylene adipate soft segments and 4,4′ methylene bisphenyl isocyanate; and 30% of an extrusion grade ABS (melt flow=2.5).

All of the overmolding Examples utilized substrates having the Sample Types designated above, however various overmolding materials were adhered onto the substrate and subsequently subjected to the peeling test as described above.

### Example 4(a)

Overmolding with Polyester Polyether Thermoplastic Elastomer

In this Example the overmolding layer adhered to the substrate was a polyester polyether thermoplastic elastomer with 36% hard PBT segment/67% soft PTMEG segment, a melting point of 190° C., and a Shore D hardness of 40D. The results of the peel test are shown below in Table 5.

TABLE 5

| | | | | First Adhesion | Second Adhesion |
|---|---|---|---|---|---|
| | | | | Result | Test Result |
| Sample | | % Non- | | (pounds/ | (pounds/linear |
| Type | % POM | acetal | % Other | linear inch) | inch) |
| 28 | 100 | 0 | 0 | | — |
| 29 | 90 | 10 | 0 | | — |
| 30 | 70 | 30 | 0 | 5-15 | 19 |
| 31 | 95 | 5 | 0 | | — |
| 32 | 90 | 10 | 0 | 3-6 | — |
| 33 | 80 | 20 | 0 | 2-4 | — |
| 34 | 90 | 10 | 0 | 1-3 | — |
| 35 | 50 | 20 | 30 | 5-8 | — |
| 36 | 55 | 15 | 30 | 6-12 | 20 |

### Example 4(b)

Overmolding with Thermoplastic Polyurethane

TABLE 6

| | | | | | Second |
|---|---|---|---|---|---|
| | | | | | Adhesion |
| | | | | | Test Result |
| Sample | % | % Non- | | Adhesion | (pounds/linear |
| Type | POM | acetal | % Other | (pounds/linear inch) | inch) |
| 28 | 100 | 0 | 0 | | — |
| 29 | 90 | 10 | 0 | | — |
| 30 | 70 | 30 | 0 | 8-16 | 22 |
| 31 | 95 | 5 | 0 | | — |
| 32 | 90 | 10 | 0 | 2-3 | — |
| 33 | 80 | 20 | 0 | 3 | — |
| 34 | 90 | 10 | 0 | | — |
| 35 | 50 | 20 | 30 | 10 | — |
| 36 | 55 | 15 | 30 | 3-6 | 6 |

### Example 4(c)

Overmolding with Styrene Butadiene Block Copolymer

TABLE 7

| | | | | | Second Adhesion |
|---|---|---|---|---|---|
| | | | | | Test Result |
| Sample | % | % Non- | % | Adhesion | (pounds/ |
| Type | POM | acetal | Other | (pounds/linear inch) | linear inch) |
| 28 | 100 | 0 | 0 | | — |
| 29 | 90 | 10 | 0 | | — |
| 30 | 70 | 30 | 0 | 23 | 23 |
| 31 | 95 | 5 | 0 | 24 | 24 |
| 32 | 90 | 10 | 0 | | — |
| 33 | 80 | 20 | 0 | 18 | 18 |
| 34 | 90 | 10 | 0 | | — |
| 35 | 50 | 20 | 30 | 20 | 20 |
| 36 | 55 | 15 | 30 | 23 | 23 |

What is claimed is:

1. An article comprising:
(a) a substrate comprising 99.5-40 weight percent of a polyoxymethylene polymer; 0.5-60 weight percent of at least one non-acetal thermoplastic polymer on or near the surface of the substrate to promote adhesion; and
(b) at least one layer adhered to the substrate.

2. The article according to claim 1, wherein the polyoxymethylene polymer is branched or linear.

3. The article according to claim 2, wherein the polyoxymethylene polymer has a number average molecular weight in the range of about 10,000 to about 100,000.

4. The article according to claim 3, wherein the polyoxymethylene polymer has a number average molecular weight in the range of about 25,000 to about 70,000.

5. The article according to claim 1, wherein the substrate comprises about 0.5 to about 20 weight percent of the at least one additional non-acetal polymer.

6. The article according to claim 1, wherein the at least one non-acetal polymer is selected from the group consisting of styrene acrylonitrile copolymers, styrene acrylonitrile copolymers copolymers toughened acrylonitrile-butadiene-styrene (ABS) resins, styrene acrylonitrile copolymers toughened with acrylonitrile-ethylene-propylene-styrene resins, polycarbonates, polyamides, polyarylates, polyphenyleneoxides and their blends, polyphenylene ethers and their blends, high impact styrene resins, acrylic polymers, imidized acrylic resins, styrene maleic anhydride copolymers, polysulfones, styrene acrylonitrile maleic anhydride resins, and styrene acrylic copolymers, and derivatives thereof.

7. The article according to claim 6, wherein the at least one non-acetal polymer is selected from the group consisting of styrene acrylonitrile copolymers, acrylonitrile-butadiene-styrene resins, acrylonitrile-ethylene-propylene-styrene resins, and polycarbonates.

8. The article according to claim 1, wherein the at least one non-acetal polymer is a semi-crystalline polymer selected from the group consisting of polyamides, polyesters and polyolefins.

9. The article according to claim 1, wherein the at least one layer is co-continuous with the substrate.

10. The article according to claim 1, wherein the at least one layer is discontinuous with the substrate.

11. The article according to claim 1, wherein the at least one layer is selected from the group consisting of thermoplastic elastomers, thermoplastic olefins, thermoplastic urethanes, polyethylene and polypropylene.

12. The article according to claim 1, wherein the at least one layer is selected from the group consisting of solvents, water latex, epoxy, urethane, and powder coating acrylic.

13. The article according to claim 1, wherein the at least one layer is selected from the group consisting of solvent-based glues, latex, epoxy, and super glue.

14. The article according to claim 1, wherein the substrate is pretreated with a surface modification technique selected from etching, flaming ionization, sanding, surface cleaning, and UV exposure.

15. A process for making the article of claim 1 comprising the steps of:
(i) blending a matrix comprising 99.5-40 weight percent of an polyoxymethylene polymer and 0.5-60 weight percent of at least one non-acetal thermoplastic polymer;
(ii) molding the matrix into a substrate; and
(iii) adhering at least one layer to said substrate.
